(19) United States
(12) Patent Application Publication
(10) Pub. No.: US 2009/0210377 A1
(43) Pub. Date: Aug. 20, 2009

(54) System and Method for Performing Dependency Management in Support of Human Reasoning in Collaborative Reasoning Networks

(75) Inventors: Daniel M. Gruen, Newton, MA (US); Susanne C. Hupfer, Lexington, MA (US); John F. Patterson, Carlisle, MA (US); Steven I. Ross, South Hamilton, MA (US)

Correspondence Address: HAMILTON, BROOK, SMITH & REYNOLDS, 530 VIRGINIA ROAD, PO BOX 9133, CONCORD, MA, 01742-9133, US

(73) Assignee: INTERNATIONAL BUSINESS MACHINES CORPORATION, Armonk, NY (US)

(21) Appl. No.: 12/403,629

(22) Filed: Mar. 13, 2009

Related U.S. Application Data
(63) Continuation-in-part of application No. 12/017,026, filed on Jan. 19, 2008.

(51) Int. Cl. G06N 5/02

(52) U.S. Cl. 706/50

(57) ABSTRACT

A dependency manager in a collaborative reasoning system tracks dependencies between and within users' reasoning by recording chains of reasoning as established by users. Elements of reasoning needing reassessment are deduced from the recorded chains of reasoning. In turn, the dependency manager propagates awareness of changes in reasoning and the elements needing reassessment by rendering graphical (e.g., visual) indicators in the user interface of the collaborative reasoning system.

### CROSS REFERENCE TO RELATED APPLICATION(S)

The present application is a Continuation-in-Part of U.S. patent application Ser. No. 12/017,026, filed Jan. 19, 2008, entitled “A System and Method for Supporting Collaborative Reasoning” herein incorporated by its entirety.

The following patent applications by assignee disclose related subject matter to that of the present invention:
U.S. patent application Ser. No. 11/867,890, filed Oct. 5, 2007, entitled “A Method and Apparatus for Providing On-Demand Ontology Creation and Extension”;
U.S. patent application Ser. No. 12/017,987, filed Jan. 22, 2008, entitled “Computer Method and Apparatus for Graphical Inquiry Specification with Progressive Summary”;
U.S. patent application Ser. No. 12/017,990, filed Jan. 22, 2008, entitled “Computer Method and System for Contexual Management and Awareness of Persistent Queries and Results”; and
U.S. patent application Ser. No. 12/035,992, filed Feb. 22, 2008, entitled “Computer Method And Apparatus For Parameterized Semantic Inquiry Templates With Type Annotations”:
Each of the foregoing in its entirety is herein incorporated by reference

### GOVERNMENT SUPPORT

This invention was made with government support under Contract No. H98230-07-C-0383 awarded by the U.S. Department of Defense. The Government has certain rights to this invention.

### BACKGROUND

Most of the interesting and challenging problems we face today are beyond the capacity of a single person to solve on their own. These problems require the effort, knowledge, and expertise of a variety of people working together to arrive at a solution. Typically, within a company or organization there will be a collection of people with varying expertise on different topics, working together and/or independently on a number of different problems or issues simultaneously. These people may not all be aware of each other's existence, expertise, current activities, or reasoning—even if the tasks they are working on may be interrelated.

Whether using a software tool, or not, people reason and make decisions—individually and/or collectively. There are reasons underlying these decisions, and chains of reasoning occur (e.g., one thinks X is true, because one thinks A is true. One thinks A is true because one thinks B is false and C is true. One thinks B is false because D happened.) Sometimes, a person or group receives new information that breaks or alters the chain of reasoning and which should cause them to re-assess some of their conclusions (e.g., if new evidence arises that indicates D did not, in fact, happen, then ultimately the truth of X may be in doubt; at the very least, B should be reassessed, and if one's belief in the falsehood of B has changed, then A should be reassessed, and so on.). The problem is that people don't necessarily remember their own chains of reasoning—especially when those chains become very complex. Moreover, the problem only becomes worse when multiple people collaborate on a reasoning problem: People may never even know the details of other collaborators' chains of reasoning. As a result, the relevant re-assessments may not take place when new information comes to light.

### BRIEF SUMMARY

The present invention addresses the foregoing problem by capturing dependencies, and hence chains of reasoning as established by users; and by making users aware of the impact of changes on chains of reasoning as they occur (dynamically), no matter who makes the changes. The present invention also makes suggestions of when and where re-assessments are needed.

The present invention manages dependencies among hypotheses, claims, and evidence in a collaborative reasoning system, and provides awareness to the users of relevant changes in both the strength and nature of evidence (strongly or moderately refuting, neutral, or moderately or strongly supporting) and in the confidence and nature of claims and hypotheses (strongly or moderately false, neutral, or moderately or strongly true). Visual indication and awareness of changes helps users to know when confidence in a particular claim or hypothesis needs to be revisited due to changes to other claims, hypotheses, or evidence that it is supported by.

Providing this awareness is especially important in a collaborative reasoning system, in which multiple users are collectively building models, since individual users are usually not familiar with the entire set of models and may not know a priori what impact their changes to claims, hypotheses, or evidence will have on other parts of the models or on other models in the collaborative reasoning system. Even if a user is building a model alone, however, the user may forget about certain dependencies and will benefit from the awareness of the impact of changes. Embodiments of the invention thus utilize the dependencies among hypotheses, claims, and evidence to help human reasoners keep track of how changes to the modeled information might impact conclusions that are being drawn from it.

In one embodiment a computer method and apparatus manage dependencies in a collaborative reasoning network. The invention method/system graphically represents reasoning by different users in a collaborative reasoning system configured to model reasoning of a plurality of users. The graphical representation (or user interface) employs non-hierarchical graph structures (e.g., model entities, claim arcs between model entities, hypothesis nodes and evidence members) to represent respective elements of reasoning by different users. The invention method/system (i.e., a dependency manager thereof) tracks dependencies between the elements of users' reasoning as dynamically established by the users. In response to user alteration of an element of reasoning (e.g., adding evidence supporting or refuting the element), the dependency manager propagates awareness of the change from the altered element to other elements of reasoning according to the tracked dependencies. The invention method/system indicates the propagated awareness in display of the graph structures corresponding to the other elements of reasoning. This is preferably accomplished by visual or graphical indicators of various geometries, colors, line types and the like. Other indicators (audio, video-based, etc.) are suitable.

Other embodiments employ combinations of hierarchical graph structures and/or non-hierarchical graph structures.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1-9 are schematic diagrams of a user interface and corresponding screen views illustrating an embodiment of the present invention.

FIG. 10 is a flow diagram of one embodiment.

FIG. 11 is a schematic view of a computer network in which embodiments of the present invention are deployed.

FIG. 12 is a block diagram of a computer node in the network of FIG. 11.

### DETAILED DESCRIPTION

A research team of Assignee (International Business Machines Corporation, Armonk, N.Y.) has been working on a system to support collaborative reasoning within or across organizations. One goal is to make use of computer and network technology to enhance the ability of people to think together about the hard problems that they face. In one prototype collaborative reasoning system, users of the system: (i) share an evolvable ontology that provides them with a common vocabulary; (ii) work both together and separately on a variety of interdependent investigations; (iii) model individuals, organizations, situations, and activities in the world; (iv) pose questions; and (v) develop hypotheses, gather evidence, and arrive at conclusions. See parent U.S. patent application Ser. No. 12/017,026 of Assignee, which gives an overview of such a collaborative reason system.

In a further development of the prototype collaborative reasoning system, the research team is developing and designing the system to make users aware of interrelated problems and solutions, and to point out opportunities for collaboration. The present invention manages dependencies and awareness in support of human reasoning within the framework of the collaborative reasoning system. In particular, embodiments of Applicants' invention support humans who are engaged in collaborative reasoning by recording their chains of reasoning as they model problems and solutions and reach conclusions. A preferred embodiment manages dependencies among hypotheses, claims, and evidence. Whenever changes are made to these items (e.g., a person changes his/her opinion of a piece of evidence associated with a hypothesis from supporting to refuting, or adds or removes a piece of evidence as a justification for a hypothesis for example), the present invention uses the recorded chain of reasoning to deduce what other items may need to be re-assessed (e.g., the hypothesis should be re-assessed, and if the assessment of it changes, then any claims or other hypotheses it supports should be re-assessed in turn). And the present invention uses visual indicators to draw users' attention to those items determined to need reassessment.

When modeling problems and their solutions using Applicants' collaborative reasoning system, users model entities, which may represent individuals, organizations, situations, activities, locations, events, and the like. Users also express claims (relationships between modeled entities) and hypotheses relevant to what is being modeled, and they express the nature and confidence of their belief in those claims and hypotheses (i.e., whether they strongly or moderately believe the hypothesis or claim to be true or false). Investigators can also justify hypotheses and claims with evidence, and for each piece of evidence, they denote its nature and strength (i.e., whether the evidence is strongly or moderately refuting, strongly or moderately supporting, or neutral).

The nature and strength of evidence may directly affect one's belief in the claim or hypothesis that the evidence has been used to justify. For example, consider a hypothesis that “Bill stole a TV”, which, as a justification, has associated with it the evidence “Jane witnessed Bill walking out of TVMax through a smashed window with a TV”. The more strongly supporting an investigator deems the associated collection of evidence to be, the more likely it is that the investigator will express strong confidence in the truth of the hypothesis. Similarly, if new evidence comes to light (e.g., evidence revealing that Jane lacks credibility), the investigator may wish to revise his/her assessment of the evidence that “Jane witnessed Bill walking out of TVMax through a smashed window with a TV” to be much less supporting of the hypothesis that Bill stole a TV. In turn, the investigator may wish to re-assess and change his/her belief in the hypothesis; e.g., if there is no other evidence supporting the robbery, perhaps now the investigator is moderately confident in the falsehood of the hypothesis.

If the hypothesis, in turn, was used as supporting evidence for another hypothesis or claim (e.g., “Bill is a habitual thief”), then that supported hypothesis (or claim) should be re-assessed as well. Toward that end, as the user models a problem/solution, the invention collaborative reasoning system automatically keeps track of the chain of reasoning. When any underlying justification is altered, the present invention deduces which items should be re-assessed and draws visual attention to those items in the collaborative reasoning system user interface.

Note that embodiments of the present invention do not compute confidences based upon a mathematical combination of supporting evidence confidence. Were an invention embodiment to do that, one could propagate confidence changes through the system of recorded dependencies much as a spreadsheet propagates changes to the value of a cell through a set of dependent formulae. Instead, in this embodiment, Applicants leave the assessment of how the confidence of a particular claim or hypothesis is affected by the confidence of its justifications to the judgment of the users, but aide users by informing them when and potentially where reassessment is needed due to changes in supporting confidence.

Although the present invention type of dependency management and awareness in support of human reasoning is heretofore not provided in the prior art, there are some prior systems that deal solely with automated, machine-based problem solving as follows.

Artificial Intelligence, by Patrick Henry Winston, 1984, Addison-Wesley, Chapter 7, “Logic and Theorem Proving”, pp. 209-251, describes logic-oriented constraint propagation, in which truth values are propagated through nodes using constraints, which are represented as logical expressions. As constraint propagation occurs, this approach can keep track of “justification links” that trace from each deduced assertion to the contributions that gave rise to it. If a contradiction occurs, the system can track back to the assumptions that led to it, and an assumption can be withdrawn. The system is able to track down other assertions that depend on the withdrawn assumption and to withdraw those in turn, if necessary. Human reasoning and decision-making plays no role in this process, however; the entire dependency system is built upon logical expressions and can be machine-automated.

In Proceedings of AAAI-90 at pages 1109-1116 “Truth Maintenance,” by David McAllester, Artificial Intelligence Laboratory, Massachusetts Institute of Technology, 1990 (Available at: citeseer.ist.psu.edu/cache/papers/cs/9061/, and www.research.att.com/dmac/survey.pdf/, and publications.csail.mh.edu/ai/AIM-1215) discusses the functionality of truth maintenance systems and compares existing algorithms.

In contrast to these systems, the collaborative reasoning system of Applicant supports human problem solving, and the invention dependency management and awareness is designed to aid human decision making.

Another system of general interest in the pertinent art is SEAS (Structured Evidential Argumentation System or SRI Early Alert System). See www.ai.sri.com seas/. SEAS has some similarities to the present invention collaborative reasoning system in that it, too, tracks dependencies and provides awareness to users of changes in evidence. Lowrance, John D. and Harrison, Ian W. and Rodriguez, Andres C. “Structured Argumentation for Analysis”, in Proceedings of the 12th International Conference on Systems Research, Informatics, and Cybernetics: Focus Symposia on Advances in Computer-Based and Web-Based Collaborative Systems, Baden-Baden, Germany, pp. 47-57, August 2000 (Available at: www.ai.sri.com/pubs/files/434.pdf).

SEAS supports the creation of “arguments” from “argument templates” and is designed to help analysts predict crises or other situations. SEAS allows the definition of argument templates, which record analytic methods as hierarchies of interrelated questions. The argument template defines what the questions are, what the possible answers are, and how the answer to each question is dependent on the answers to the questions immediately below it in the tree. Users choose an appropriate argument template and use it to construct an “argument,” by answering the questions at the leaves. The argument combines answers at the leaves to answer questions one level above—either by an automatic inference method or by involving a human decision-maker. Questions further up the tree are answered in turn in the same manner. The templates are, in effect, decision procedures that are in part manually executed by the user in constructing the argument. Evidence may be recorded to support the answers to the questions at the leaf nodes, and SEAS provides awareness to the user of changes, e.g., that new evidence has arrived and needs to be considered.

Despite some similarities, the present invention collaborative reasoning system and SEAS are quite different:

(i) While SEAS supports hierarchal argument structures that remain static as users answer questions to construct an argument, applicant's invention system supports non-hierarchical graph/network structures that grow and shrink dynamically as users add or delete elements while reasoning together.

(ii) The invention collaborative reasoning system is more flexible and dynamic, allowing users to construct and refine models on the fly, without needing to choose from pre-existing templates at the outset.

(iii) While both systems have a notion of dependencies, the dependencies in SEAS are dictated by the static tree structure of an argument and are thus known by all users right from the outset. In contrast, the dependencies in the invention collaborative reasoning system models are not obvious from the graph's structure, can be altered by multiple users at any given time, and are more fluid, that is, (a) evidence may be used to support a claim or hypothesis, (b) claims and hypotheses may be used to support other claims and/or hypotheses, and (c) evidence, claims and hypotheses may be added, deleted, or modified at any time.

(iv) Whereas SEAS users can only add evidence at the leaf nodes in an argument's hierarchy, in the invention collaborative reasoning system users can add/modify/delete evidence for any claim or hypothesis in a model. Both SEAS and Applicants' collaborative reasoning system have the notion of using dependencies to propagate awareness of relevant changes. However, in SEAS this just means propagation along the tree-structured dependency relationships between questions established in the pre-existing argument template, whereas in the invention collaborative reasoning system the dependency propagation is through the dynamic graph/network of justifications established by the user.

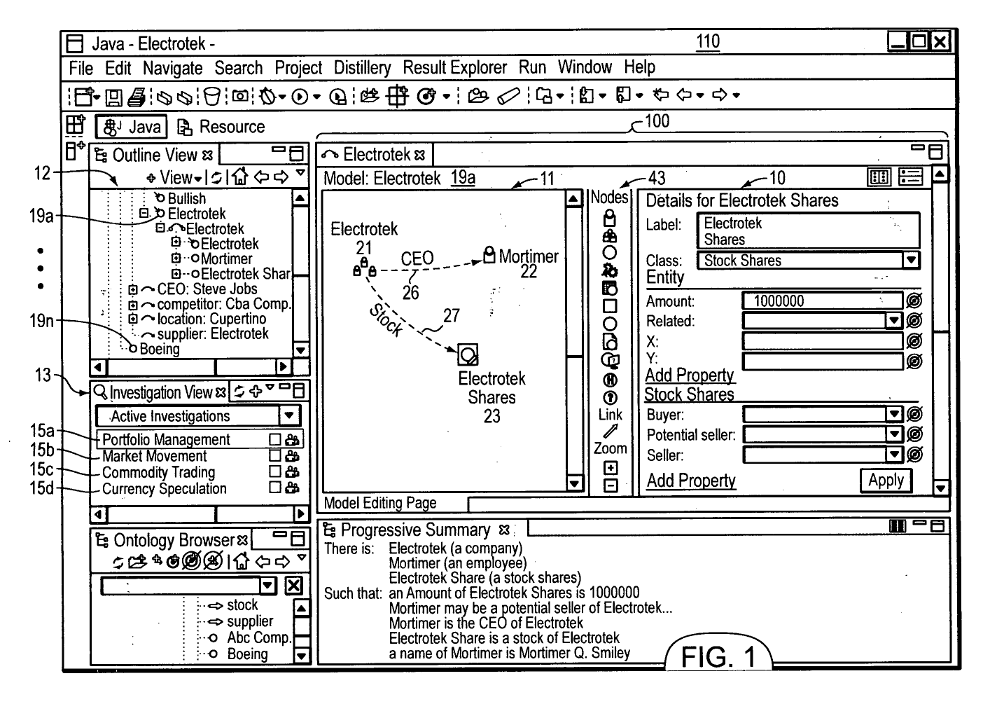

These distinctions and other features of embodiments of the present invention are made more clear with the following description of a non-limiting example embodiment. The example embodiment description and corresponding depictions in FIGS. 1-9 are for purposes for illustration and not limitation.

With reference to FIG. 1, the preferred embodiment of the present invention 100 is implemented as part of a modeler in collaborative reasoning system 110. Preferably collaborative reasoning system 110 is a computer application that supports collaborative reasoning, built on top of Eclipse using Java, and permits users to create any number of “Investigations” 15 a, b, c, . . . n (generally 15). Each investigation 15 is formed of any number of “Models” 19 a, b, c, . . . n (referenced 19 generally). Users create graphical models of problems (or problem solutions).

FIG. 1 shows the collaborative reasoning system 110 user interface of a user (perhaps an investment analyst) who has several “Active Investigations” 15a, b, c . . . n (shown on the left side of the UT, in the middle panel 13 entitled “Investigation View”). The user is currently focused on the investigation 15a called “Portfolio Management” (highlighted in the Investigation View 13). The hierarchical structure of the “Portfolio Management” investigation 15a is shown in the panel at the upper-left, entitled “Outline View” 12. The “Portfolio Management” investigation 15a comprises models 19a, b . . . n of several different companies. The user has opened the model 19a for the “Electrotek” company. The Outline View 12 at the upper left of FIG. 1 shows the model 19a for Electrotek in outline form, and the center panel 11 shows a graphical representation of the model 19a. The graphical representation shows nodes 21, 22, 23 that represent the Electrotek company, its CEO (labeled Mortimer), and shares of its stock, respectively. The arcs 26, 27 connecting the nodes 21, 22, 23 represent relationships between those entities.

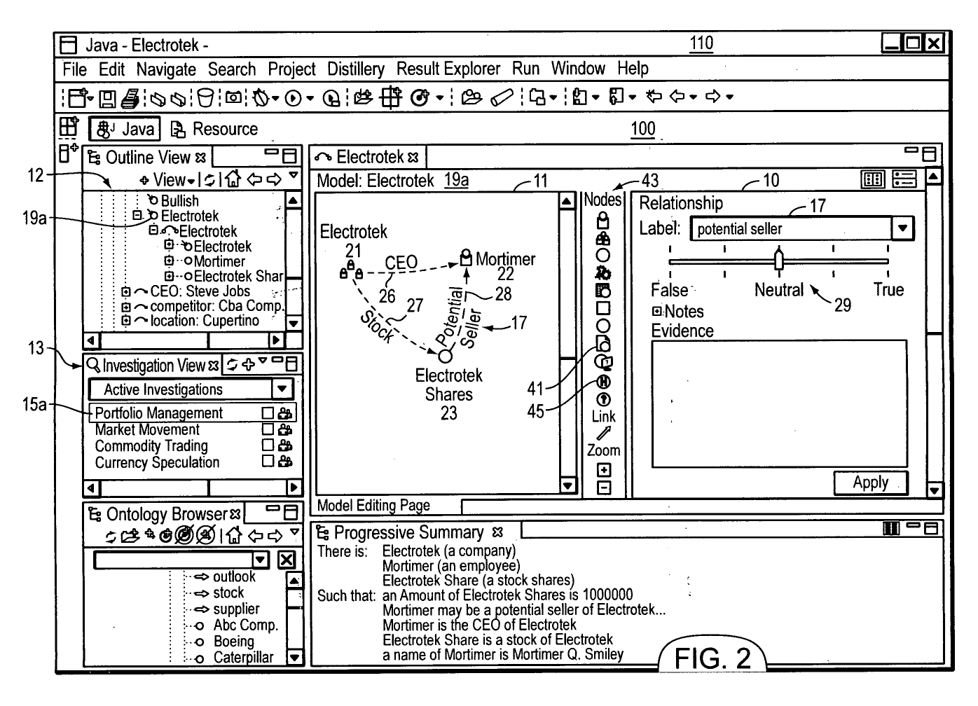

The user has selected the modelled entity labeled “Electrotek Shares” (node 23) and has entered an Amount for the entity, namely 1,000,000 shares (as shown in the Details pane 10 at the right of FIG. 1). The present invention 100 is preferably a dependency manager module or engine in the modeler of collaborative reasoning system 110. Modeler/dependency manager 100 establishes a relationship between the Electrotek CEO, Mortimer, and the 1,000,000 shares of Electrotek stock when the user interacts with model 19a by creating an arc 28 (FIG. 2) to connect those entities (represented by nodes 22, 23). As shown in the Details pane 10 at the right, the user specifies a label for arc 28 and modeler 100 displays the arc 28 with the user-specified label “potential seller”, to denote the claim that the CEO (node 22) is a potential seller of 1 million shares of Electrotek stock (node 23). So far, the arc/relationship 28 is displayed as a dotted line (with “potential seller” label 17), which indicates that there is no evidence yet to back up the claim.

Given the lack of evidence, the user chooses to leave the slider 29 for the claim/relationship (shown in the Details pane 10) in the “neutral” position, since the user currently has no particular belief in the falsehood or truth of the claim.

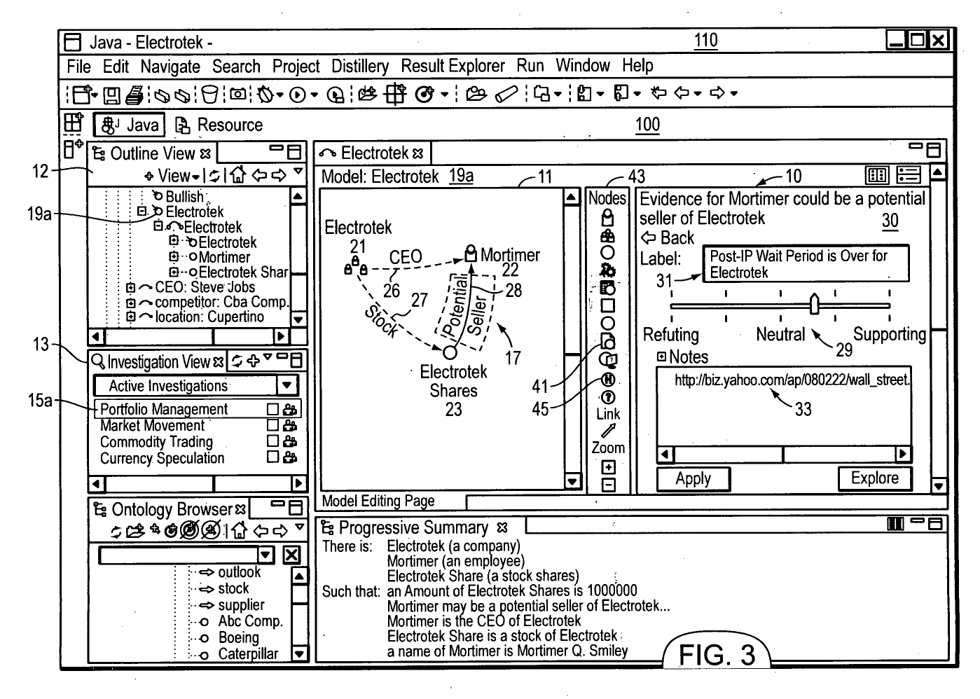

Now suppose some evidence comes to light that is supportive of the claim that the CEO is a potential seller of one million Electrotek shares. This evidence could be created manually via the “Evidence” icon 41 in the “Nodes” palette 43 of the collaborative reasoning system 110 user interface, or it could be created by dragging (or otherwise providing) items onto the graph, or through some other mechanism. For example, suppose a user dragged (or otherwise operated) a representation of a business news article into the graph of model 19a and dropped/positioned (or otherwise associated) it onto the “potential seller” arc/relationship 28 to use it as justification for that claim. It is important to note that this is a collaborative system, so the user who discovers and applies evidence may or may not be the same user who originally created the subject model 19a. The Details pane 10 (as generated by invention modeler/manager 100) of FIG. 3 shows details for such a piece of evidence 30, including a label 31 that may be derived from the article, e.g., “Post-IP Wait Period is Over for Electrotek”, and a URL 33 linking to the source of the article. In turn, the user has changed the slider 29 to mark the evidence as “somewhat supporting” (i.e., supporting, but not all the way over to the “strongly supporting” value at the far right of the slider). Since the user has applied this evidence 30 to the “potential seller” relationship, represented by arc/relationship 28, the invention/modeler/dependency manager 100 changes the line type of arc 28 from a dotted line to a solid line, indicating that the claim now has evidence associated with it.

Any user who now looks at the Electrotek graph view (e.g., at 11) of model 19a sees an indication that something has changed with respect to the “potential seller” relationship 28. In particular, the graph view visually indicates existence of evidence 30 with a solid line depiction of arc 28, and the view visually indicates strength or other characteristic of belief in the truth or falsehood of the relationship/claim, e.g., via predefined colors and line thicknesses. The “potential seller” label 17 is displayed in a certain color (e.g., in a predefined color purple, indicated by a dashed line box in FIG. 3) to indicate that there has been a change in the underlying evidence (i.e., in this case that a new piece of evidence has been added to support the relationship) and that reassessment of the claim is needed. This is only one technique to draw users' attention to the fact there has been an underlying change to the claim. Other alternate or additional graphical, visual, audible, or the like awareness techniques are possible.

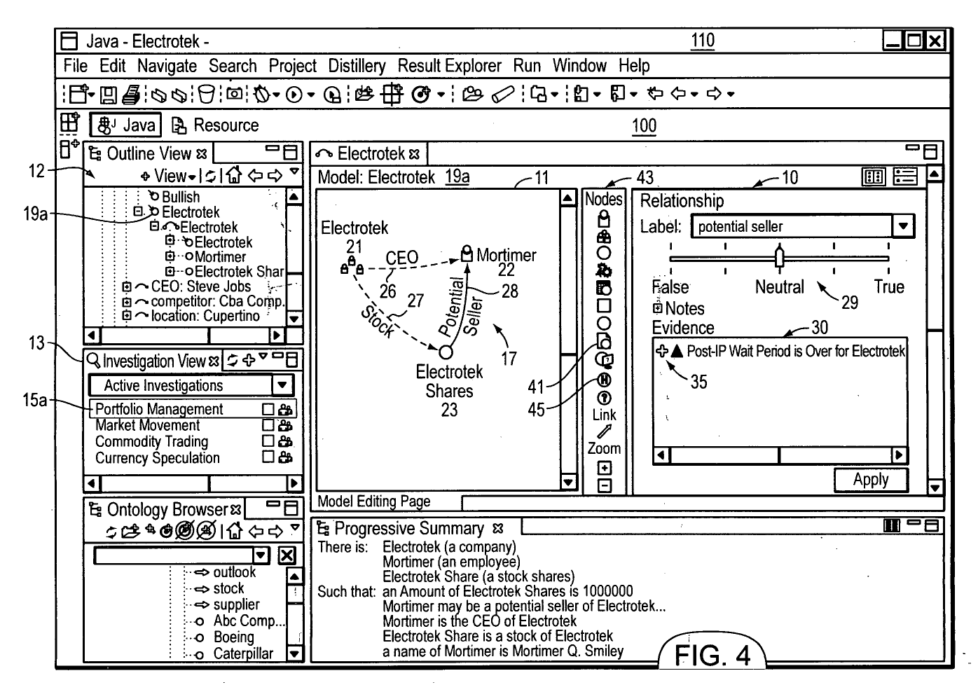

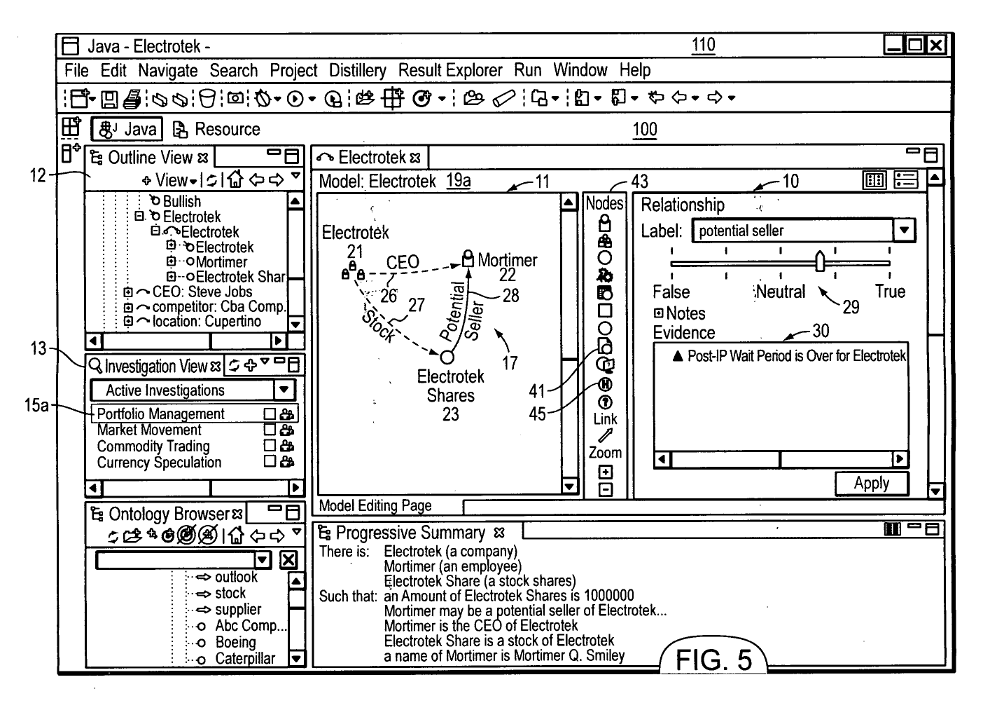

Subsequently, if a user selects the “potential seller” arc 28, the present invention dependency manager 100 generates the Details pane 10 as shown in FIG. 4 with a listing of the new piece of evidence 30. The invention manager 100 uses graphical indicators to reveal that 1) the piece of evidence 30 is new as shown by the “plus” (“+”) glyph 35 to the very left of the evidence, and 2) the evidence 30 is supportive of the claim (as shown by the upward triangle just to the left of the evidence). A user may decide to readjust the slider 29 for the “potential seller” claim (e.g., to the right of neutral, for instance, to somewhat true or strongly true), in light of the new evidence 30. If that is done, dependency manager 100 removes the “plus” glyph 35 (so it disappears from display) indicating that someone has paid attention and reacted to the new evidence 30, so it's no longer “new” (as shown in FIG. 5).

In addition, dependency manager 100 no longer displays the “potential seller” label 17 in the distinct color (e.g., purple) to indicate a new, not-yet-reacted-to change. Instead dependency manager 100 reverts to the color representing the associated confidence. One embodiment uses blue for positive, red for negative, and grey for neutral confidence. Other color schemes, font patterns, graphical effects and the like may be employed.

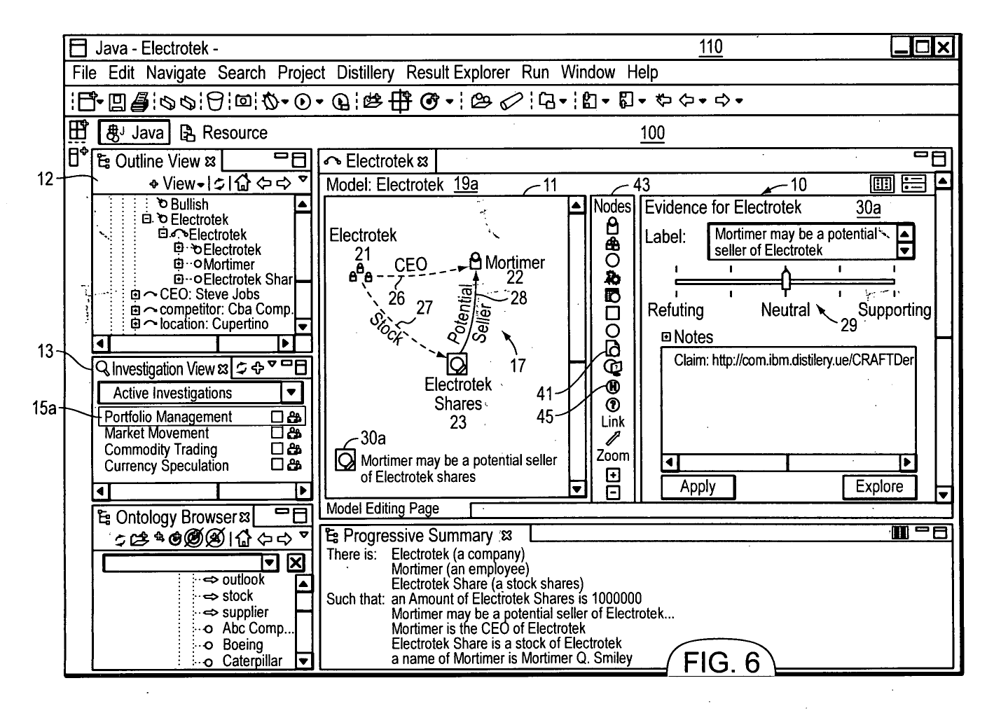

It is important to note that the same visual awareness mechanisms come into play when evidence is used to support a Hypothesis node 61, not just when it is used to support a claim arc 26, 27, 28. For example, suppose a user right-clicks (or otherwise operates an appropriate function) on the “potential seller” arc 28. The collaborative reasoning system 110 and invention modeler/manager 100 make a menu appear and allow the user to “Create Evidence” from that claim. In turn, dependency manager 100 displays, a new piece of Evidence 30a based upon that claim in the model 19a, as shown in FIG. 6.

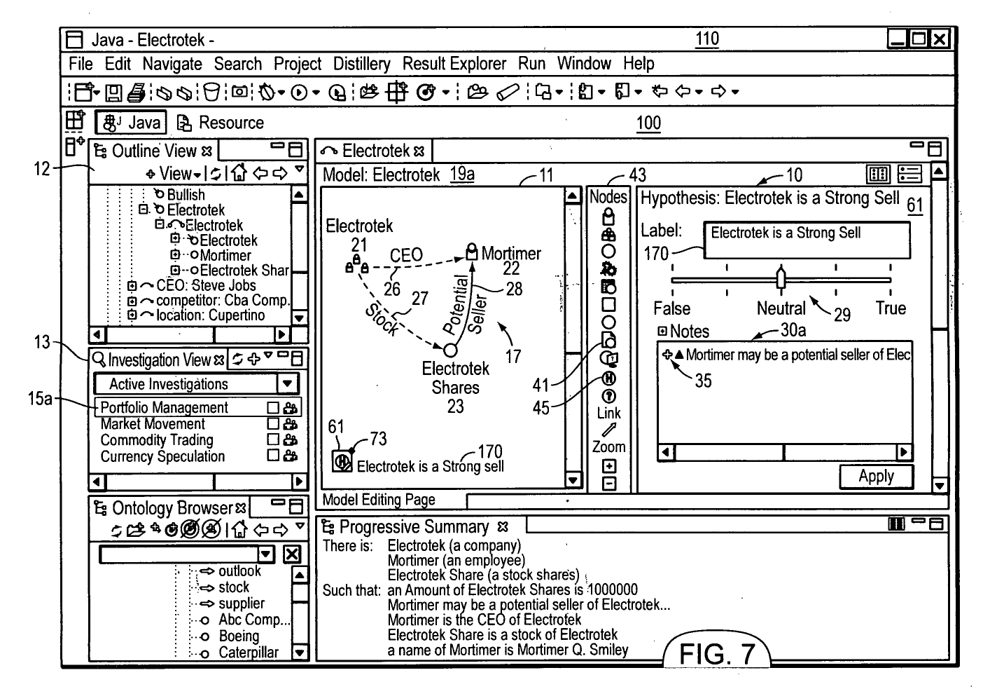

Now suppose the user drags a “Hypothesis” icon 45 onto the graph (model 19a) from the palette 43, creating a hypothesis entity 61, and gives it a label 170 “Electrotek is a Strong Sell.” Next, suppose the user drags the Evidence entity 30a “Mortimer may be a potential seller of Electrotek Shares”, which was derived from the “potential seller” claim 28, onto the new hypothesis entity 61, thereby associating that evidence with the hypothesis, and uses a slider 29 (shown in FIG. 6) to mark it as somewhat supportive of the hypothesis. FIG. 7 shows the resulting display and interface generated by invention modeler/dependency manager 100.

One embodiment displays a purple (predefined color) diamond decorator 73 on the “Electrotek is a Strong Sell” hypothesis node 61 to indicate that there is a change in the evidence associated with that hypothesis (in this case, new evidence 30a). The invention dependency manager 100 also produces (e.g., colorizes) label 170 “Electrotek is a Strong Sell” to appear in a distinctive predefined colored (e.g., purple) text to indicate a change in underlying evidence. The dependency manager 100 lists in Details pane 10 the associated evidence 30a and, just as illustrated above in the case of claims 26, 27, 28, the “plus” (“+”) decorator 35 indicates that the piece of evidence 30a is new and the upward arrow indicates that the evidence is supportive of the hypothesis 61. In one embodiment 100, evidence 30, 30a that has been deleted from a Hypothesis 61 (or claim 26, 27, 28), is listed with a “minus” (“−”) decorator and clearly marked as having been deleted. If evidence 30, 30a (for a Hypothesis or Claim) is refuting, rather than supporting, it is displayed with a downward triangle decorator (rather than the upward triangle for supporting evidence).

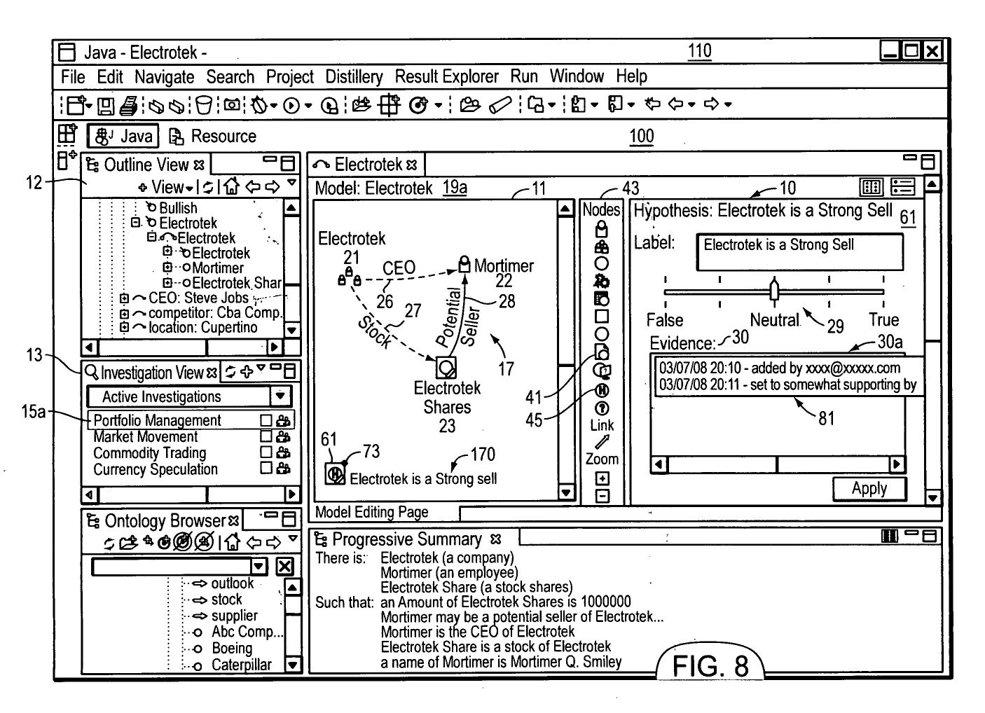

Turning to FIG. 8, another function of invention modeler/dependency manager 100 is shown. To find out more about what has transpired with a piece of evidence 30, 30a, the user can mouse over (or otherwise hover the cursor over) any piece of listed Evidence 30, 30a in Details pane 10. In response, manager 100 generates a tooltip 81 that displays a log of actions relating to that Evidence 30, 30a since the last time the supported hypothesis 61 (or claim 26, 27, 28) was assessed (see FIG. 8).

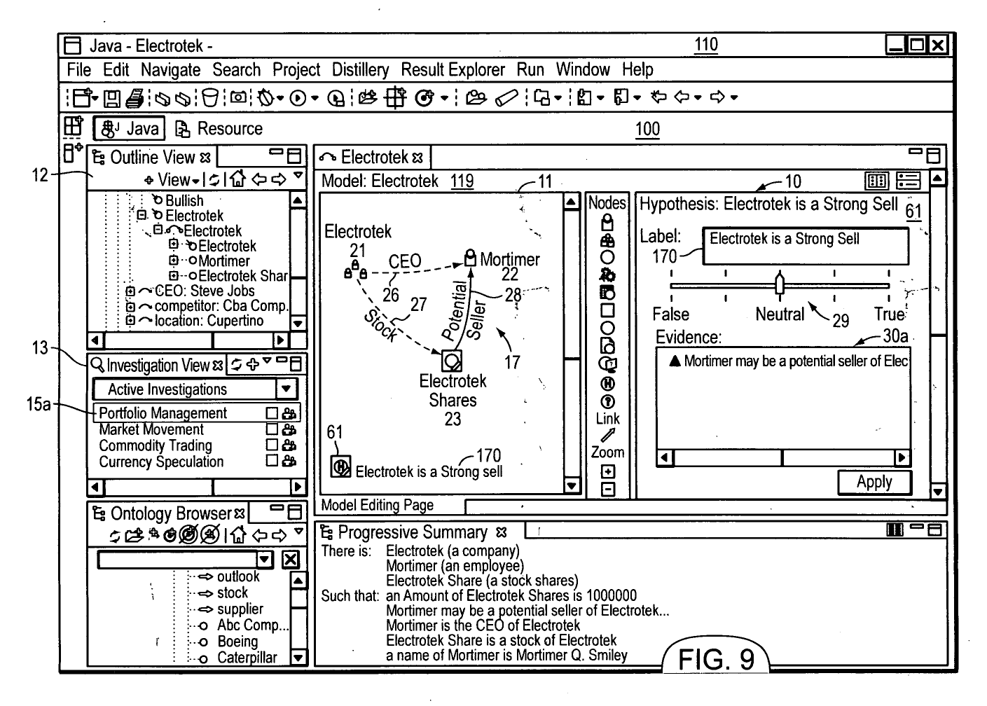

Once again, similar to claims 26, 27, 28 discussed above, if any user now readjusts the slider 29 (FIG. 8) for the Hypothesis 61, e.g., to be to the right of neutral and toward the “true” extreme at the right, that readjustment results in the dependency manager 100 removing new/plus decorator 35 from display as illustrated by FIG. 9. Also the dependency manager 100 dims/changes/or removes from display the purple (colored) “change” indicator 73 on the Hypothesis entity 61 in the graph, as well as the distinctive purple (colored) text for the label 170, since the Hypothesis has been “reassessed” in light of the new evidence 30a (also shown in FIG. 9). This is also the case when evidence 30, 30a is removed from a Hypothesis 61 (or claim 26, 27, 28) and also when the slider 29 for an underlying piece of evidence changes. If the user hovers the cursor over the piece of evidence now in the Details pane 10, the dependency manager 100 displays tooltip 81 in an empty state, since all new changes to the evidence have been “processed” by virtue of the fact the Hypothesis slider 29 was adjusted.

Further, suppose new evidence 30 (generally) comes to light that affects the “potential seller” arc/claim 28. For instance, suppose an analyst discovers a new news article that indicates the SEC has imposed an additional post-IPO waiting period on Electrotek executives before they are permitted to sell their shares. Suppose the analyst associates this new piece of evidence 30 with the “potential seller” claim 28, and uses the evidence's slider 29 to mark the evidence as “strongly refuting” of the claim. Either this analyst, or another one who notices the color change in the arc's label 17, may now decide to change the assessment of the claim 28 that the CEO is a potential seller of 1 million shares of Electrotek stock. In light of the new news, suppose the analyst moves the slider 29 for that claim 28 all the way to the extreme left, to indicate that the claim is “false”. Since the claim 28 itself was used as evidence for the “Electrotek is a Strong Sell” hypothesis 61, and since the assessment of the claim's 28 truth/falsehood has changed, dependency manager 100 once again displays the hypothesis 61 with graphical indicators of underlying change, i.e., the purple label 170 text and the purple diamond glyph 73. An analyst who notices these graphical indicators may decide to revisit the hypothesis 61, and may in fact use the hypothesis's slider 29 to change the belief from “somewhat true” to either “somewhat false” or “strongly false”.

Present invention dependency manager 100 and hence collaborative reasoning system 110 keep track of the dependencies among evidence 30, 30a, claims (e.g., 26, 27, 28), and hypotheses 61. Through the use of various visual cues throughout the graphical editor and Details pane 10 (e.g., patterns, small decorators/indicators, color changes, log entries, and the like), invention dependency manager 100 is able to keep users apprised in real-time of changes that are occurring in these dependencies and in the chains of reasoning that underlie the models 19a, b . . . n the users are building. Whenever evidence 30, 30a changes (e.g., added, deleted, or has its supporting/refuting status altered), and whenever claims 26, 27, 28 or hypotheses 61 change (e.g., when their truth/falsehood status is altered), dependency manager 100 automatically determines what other elements in the collaborative reasoning system 110 may need to be reassessed, and provides visual cues to the users to that effect.

This automated management and awareness of dependencies can be useful even for users working alone (since people do not always remember their chains of reasoning and therefore may not immediately realize the impact of changes on their earlier reasoning), and is particularly useful in a collaborative reasoning system (e.g., 110), where multiple users are all reasoning together and may not always be aware of the chains of reasoning that other users have employed.

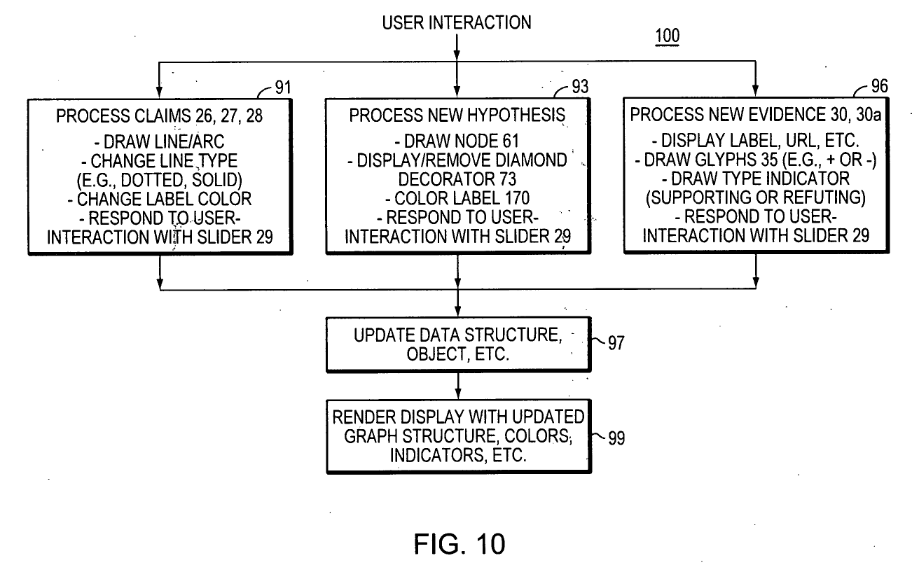

With reference now to FIG. 10, illustrated is an example of flow of program data and control in an embodiment of the present invention modeler/dependency manager 100. In response to user interaction with a model graph view (e.g., via panes 10, 11 described above), modeler/dependency manager 100 edits graph structures, i.e., model elements 21, 22, 23, claims 26, 27, 28, Hypothesis nodes 61 and evidence entities 30, 30a. Editing (adding, deleting, changing, etc.) or otherwise processing 91 of claims involves drawing (adding) a line or arc 26, 27, 28, setting line type and changing label coloring. Step or processing module 91 sets or updates line type as a function of the existence of evidence associated with the claim. In the above described and depicted example of FIGS. 1-9, modeler/dependency manager 100 employs a dotted line type to indicate no associated evidence exists and a solid line type to indicate that evidence does exist. Other embodiments may employ different line thicknesses to further indicate extent (e.g., total volume) of evidence, weight (e.g., net confidence level) of evidence etc. Other graphical variations (symbols, visual effect, and the like) are suitable.

In one embodiment, step 91 sets the label font to one (predefined) color to indicate a neutral confidence in the claim, sets the label font to another color (predefined) to indicate a positive confidence in the claim, and sets the label font to a third color (predefined) to indicate a negative confidence in the claim. Step 91 may use a fourth color (predefined) to indicate that there are underlying changes to the evidence associated with the claim. Other color schemes are suitable and may include label background colorings instead of or in addition to label font colorings to make certain visual indications to the end users.

Next step/processing module 91 is responsive to user operation of slider 29 to indicate strength of the claim. If the user positions slider 29 to neutral, slightly true, true or opposite extreme settings, step 91 changes presentation of the claim accordingly. Further, processing module/step 91 clears the log of activities supporting tooltip 81 display of corresponding evidence.

Also, if a claim is determined to be false, step 91 in one embodiment may remove the line/arc but preserve claim history for display to end users.

Next, modeler/dependency manager 100 adds or changes hypotheses by processing step or module 93. In response to user interaction with hypothesis icon 45 and hypothesis entities 61 (as described in FIGS. 6 and 7 above), step 93 draws or updates hypothesis node 61, diamond (or other) decorator 73 and hypothesis label 170. In particular step 93, displays or removes diamond decorator 73 as a function of change in or newness of evidence associated with the subject hypothesis. Upon a user adding new evidence 30, 30a to (associating it with) the hypothesis, and/or removing evidence 30, 30a from association with the hypothesis, and/or changing the slider 29 for a piece of evidence (to pick a new assessment of refuting, neutral, or supporting), step 93 draws (displays) change decorator/indicator 73 in the graph view. Upon a user interacting with a slider 29 for the hypothesis node 61 (to pick a new assessment of false, neutral, or true), step 93 removes decorator 73 from view to indicate that corresponding hypothesis has been reassessed in light of any underlying evidence changes.

Step 93 colorizes hypothesis label 170 with one color (e.g., purple) to indicate that a change in underlying evidence has occurred, such as new evidence 30a has newly been associated with hypothesis node 61. Subsequently, step 93 changes or updates color of hypothesis label 170 to another color (e.g., to typical black) to indicate that the hypothesis has been reassessed and thus, any new evidence has been considered.

Lastly step 93 responds to user interaction with slider 29 of the hypothesis node 61. When a user sets slider 29 closer to or farther away from “True” end of the scale, step 93 displays indications (e.g., colors) that indicate confidence in the hypothesis (which may stem from the user's belief in the aggregate supportiveness of the underlying evidence). Also with user interaction with slider 29, step 93 clears the log supporting the tooltip 81 display for the corresponding evidence.

Processing step 96 adds or updates evidence elements 30, 30a in response to user interaction. When a user adds evidence to the model 19, step/module 96 configures and draws a corresponding label (text phrase), URL (hyperlink to source article), etc. Next, for newly added evidence element 30 of a claim or hypothesis, step 96 adds to the evidence element a graphical indicator (e.g., “+” glyph 35) revealing that the evidence is new. When a user adjusts the associated/corresponding claim or hypothesis, step 96 removes from display the glyph 35. When a user removes the piece of evidence 30, from the model 19, step 96 marks the evidence with a respective indicator or similar decorator.

Further, with respect to a newly added evidence element 30 to a claim or hypothesis, step 96 generates an indicator to visually signal whether the evidence is supportive or refuting of the claim or hypothesis. In one embodiment, step 96 uses an upward triangle graphic to indicate supportive evidence and a downward triangle graphic to indicate refuting evidence.

Step 96 responds to user operation of evidence slider 29. When the user sets slider 29 closer to or farther away from “supporting”, step 96 displays visual indications that the corresponding evidence is supportive of or refuting a claim or hypothesis. Step 96 maintains a respective log of or otherwise records activity of each piece of evidence. The recorded activity includes slider 29 settings/values, add/remove history of the evidence and so forth, to support tooltip 81 display. Known or common tooltip techniques are employed.

The processing accomplished by steps 91, 93, 96 is followed by step 97. Step 97 updates and maintains the data structures or programming objects implementing and supporting model elements/nodes 21, 22, 23, claims 26, 27, 28, hypothesis nodes 61 and evidence pieces 30, 30a. Example data structures are linked lists and other data stores with a respective data element or data entry for each graph structure (model elements/nodes, claim, hypothesis node and piece of evidence). Each data element carries (i) definition, of which model element/claim/hypothesis/evidence it corresponds to and supports, (ii) attributes of label text, label color, graphical indicators/decorators, color of each such indicator, line type accordingly, tooltip and so on, and (iii) pointers, links or other mechanisms for tracking association (or relationship) including dependencies to other graph structure(s) in the model 19. Step 97 updates attribute values, tooltip log and pointers/links according to the processing of steps 91, 93, 96.

Other programming techniques and data structures for implementing the foregoing are suitable. Effectively, the foregoing records chains of reasoning as established by users (during dynamic changing of elements of reasoning) and propagates awareness by deducing elements needing reassessment from the chain.

In turn, step 99 renders the graph view with updated graph structures, updated label and other coloring and updated indicators/decorators/glyphs 35, 73 according to the principals of the present invention. That is modeler/dependency manager 100 generates graph views of the subject model 19 in a manner that visually (graphically) indicates dependencies (changes, additions) between model elements, claims, hypothesis and pieces of evidence.

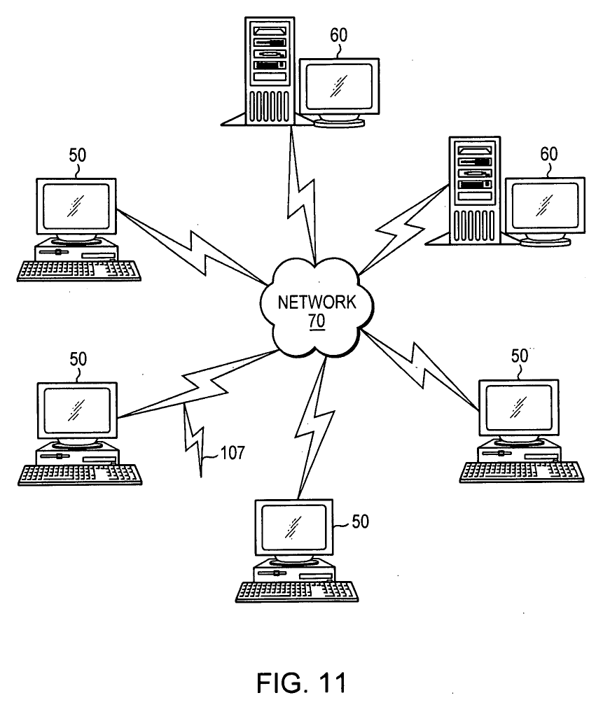

FIG. 11 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

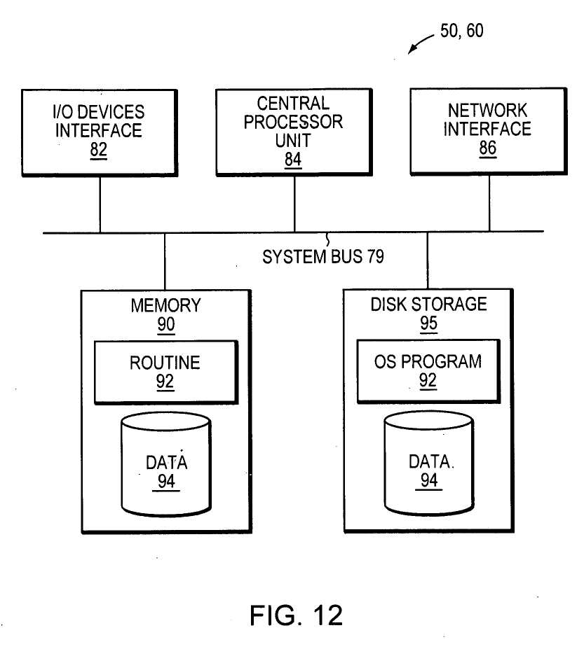

FIG. 12 is a diagram of the internal structure of a computer (e.g., client processor/device 50 or server computers 60) in the computer system of FIG. 11. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 11). Memory 90 provides volatile storage for computer software instructions 92 and data 94 used to implement an embodiment of the present invention (e.g., collaborative reasoning system modeler/dependency manager 100 code and modules detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of managing dependencies in a collaborative reasoning network, comprising computer implemented steps of:
in a collaborative reasoning system configured to model reasoning of a plurality of users, graphically representing reasoning by different users, said step of graphically representing including employing graph structures to represent respective elements of reasoning by different users;
tracking dependencies between the elements of reasoning by users;
in response to user alteration of an element of reasoning, propagating awareness of the change from the altered element to other elements of reasoning according to the tracked dependencies; and
indicating the propagated awareness in display of graph structures corresponding to the other elements of reasoning.

2. A method as claimed in claim 1, wherein the elements of reasoning include claims, hypotheses and evidence; and
wherein the graph structures are any combination of non-hierarchical structures and hierarchical structures and include:
(a) arcs representing claims that are relationships between any of individuals, organizations, entities, events, locations and activities of a problem being modeled; and
(b) hypothesis nodes representing hypotheses indicative of the problem being modeled.

3. A method as claimed in claim 1, wherein the step of tracking dependencies includes effectively recording a chain of reasoning as established by the users; and
the step of propagating awareness deduces elements needing reassessment from the recorded chain.

4. A method as claimed in claim 1, wherein the step of indicating the propagated awareness includes rendering visual indicators.

5. A method as claimed in claim 4, wherein the visual indicators include any one or combination of:
colored labels, a plus glyph, a minus glyph, different line types, line colors and geometric decorators.

6. A method as claimed in claim 1, wherein the alteration of the element includes added or deleted evidence with respect to the element.

7. A method as claimed in claim 6, further comprising indicating or modifying nature and strength of the evidence.

8. A method as claimed in claim 1, wherein user alterations of elements is by multiple users at any time and correspond to any of addition to, deletion of and modification of respective elements of reasoning in a dynamic manner.

9. Computer apparatus managing dependencies in a collaborative reasoning network, comprising:
a user interface graphically representing reasoning by different users in a collaborative reasoning system, the user interface including graph structures configured to represent respective elements of reasoning by different users, and configured to be alterable by multiple users, at any time, corresponding to changes in respective elements of reasoning by users;
a dependency manager responsive to the user interface and tracking dependencies between elements of users' reasoning, the dependency manager, in response to user alteration of an element of reasoning, propagating awareness of the change from the altered element to other elements of reasoning according to the tracked dependencies; and
wherein the dependency manager generates indicators indicating the propagated awareness in display of the graph structures corresponding to the other elements of reasoning.

10. Computer apparatus as claimed in claim 9, wherein the elements of reasoning include claims, hypotheses and evidence; and
wherein the graph structures are non-hierarchical and include:
(a) arcs representing claims that are relationships between any of individuals, organizations, entities, events, locations and activities of a problem being modeled; and
(b) hypothesis nodes representing hypotheses indicative of the problem being modeled.

11. Computer apparatus as claimed in claim 9, wherein the dependency manager tracks dependencies by effectively recording a chain of reasoning as established by the users, and propagates awareness by deducing elements needing reassessment from the recorded chain.

12. Computer apparatus as claimed in claim 9, wherein the dependency manager generates visual indicators including any of colored labels, glyphs, different line types, line colors and geometric decorators.

13. Computer apparatus as claimed in claim 9, wherein the alteration of the element includes added (or deleted) evidence with respect to the element.

14. Computer apparatus as claimed in claim 13, wherein the alteration of the element further includes indicating or changing the nature and strength of the evidence with respect to the element.

15. Computer apparatus as claimed in claim 9, wherein user alterations of elements is by multiple users at any time and correspond to any of addition to, deletion of and modification of respective elements of reasoning in a dynamic manner.

16. A computer-based collaborative reasoning system, comprising:
a modeler enabling a plurality of users to model their reasoning, in each model the modeler employing graph structures to represent respective elements of different users' reasoning, the graph structures configured to be alterable by multiple users at any time corresponding to changes in respective elements of users' reasoning;
a dependency manager coupled to the modeler and tracking dependencies between elements of users' reasoning, and in response to user alteration of an element of reasoning, the dependency manager propagating awareness of the change from the altered element to other elements of reasoning according to the tracked dependencies; and
wherein the dependency manager generates graphical indicators of the propagated awareness in display of the graph structures corresponding to the other elements of reasoning.

17. A computer-based collaborative reasoning system as claimed in claim 16, wherein the dependency manager generates graphical indicators having visual effect employing any of color, glyphs, different line types and colors and geometric decorators.

18. A computer-based collaborative reasoning system as claimed in claim 16, wherein the elements of reasoning include claims, hypotheses and evidence; and
wherein the graph structures are non-hierarchical and include:
(a) arcs representing claims that are relationships between any of individuals, organizations, entities, events, locations and activities of a problem being modeled; and
(b) hypothesis nodes representing hypotheses indicative of the problem being modeled.

19. A computer-based collaborative reasoning system as claimed in claim 16, wherein the alteration of the element includes any one or combination of added evidence, nature of the evidence and strength of the evidence.

20. A computer program product for managing dependencies in a collaborative reasoning system, the computer program product comprising:
a computer useable medium having computer useable program code embodied therewith, the computer useable program code including:
computer useable program code configured to graphically represent reasoning by different users in a collaborative reasoning system modeling reasoning of a plurality of users, said computer useable program code including in graphical representations of reasoning at least non-hierarchical graph structures to represent respective elements of reasoning by different users;
track dependencies between the elements of reasoning by users;
in response to user alteration of an element of reasoning, propagate awareness of the change from the altered element to other elements of reasoning according to the tracked dependencies; and
indicate the propagated awareness in display of graph structures corresponding to the other elements of reasoning.
